(19) United States
(12) Patent Application Publication
(10) Pub. No.: US 2009/0289158 A1
(43) Pub. Date: Nov. 26, 2009

(54) POLE MOUNTING OUTRIGGERS

(75) Inventors: Michael J. Nelson, Prior Lake, MN (US); Kevin Thompson, Chaska, MN (US)

Correspondence Address: FOGG & POWERS LLC, 5810 W 78TH STREET, SUITE 100, MINNEAPOLIS, MN, 55439, US

(73) Assignee: ADC TELECOMMUNICATIONS, INC., Eden Prairie, MN (US)

(21) Appl. No.: 12/432,880

(22) Filed: Apr. 30, 2009

Related U.S. Application Data
(60) Provisional application No. 61/055,682, filed on May 23, 2008.

(51) Int. Cl. F16M 13/00; A47B 96/06

(52) U.S. Cl. 248/220.21; 248/351; 248/354.5

(57) ABSTRACT

An outrigger is provided. The outrigger includes an arm including a receiving portion, an arm-strapping yoke pivotally coupled to the receiving portion of the arm, and at least one securing pin received in the arm-strapping yoke. The arm-strapping yoke has at least one engaging edge. The at least one securing pin is configured to force the at least one engaging edge of the arm-strapping yoke into a surface of a structure when a banding strap received in the arm-strapping yoke is tightened around the structure and the at least one securing pin.

This application claims the benefit of U.S. Provisional Application No. 61/055,682, filed on May 23, 2008, which is incorporated herein by reference in its entirety.

### BACKGROUND

A common method of providing utilities to customers is attaching devices such as communication hardware to utility poles. In many cases, the shape of the device and the shape of the utility pole are such that it is difficult to securely attach them to each other. Since the utility poles are typically outside and sometimes subjected to strong winds it is critical that the attachment of the communication hardware to a utility pole be stable and secure. The utility poles can differ in diameter, for example, from 6 inches to 18 inches, so that different models of mounting devices are required for the different diameter poles. A provider of mounting devices must have an inventory of many models to accommodate all the various structures and poles to which a device is attached.

### SUMMARY

The present application relates to an outrigger. The outrigger, in one embodiment, includes an arm having a receiving portion, an arm-strapping yoke pivotally coupled to the receiving portion of the arm, and at least one securing pin received in the arm-strapping yoke. The arm-strapping yoke has at least one engaging edge. The at least one securing pin is configured to force the at least one engaging edge of the arm-strapping yoke into a surface of a structure when a banding strap received in the arm-strapping yoke is tightened around the structure and the at least one securing pin.

The present application also relates to a mounting system. The mounting system includes at least one banding strap and at least one outrigger. The at least one banding strap is configured to pass around a structure. Each outrigger includes an arm having a receiving portion, an arm-strapping yoke pivotally coupled to the receiving portion of the arm, and at least one securing pin received in the arm-strapping yoke. The arm-strapping yoke has at least one engaging edge. The at least one securing pin is configured to force the at least one engaging edge of the arm-strapping yoke into a surface of the structure when a banding strap received in the arm-strapping yoke is tightened around the structure and the at least one securing pin.

The present application also relates to a method of mounting a housing to a structure. The method includes pivotally coupling at least one arm to the housing via a respective at least one pivot pin, pivotally coupling at least one arm-strapping yoke to a respective one of the at least one arm via a respective at least one coupling pin, attaching a mounting bracket to the structure, securing the housing on the mounting bracket via at least one mounting plate attached to the housing, retaining at least one banding strap in the at least one arm-strapping yoke via at least one securing pin, and cinching the banding straps to the structure so that the at least one engaging edge of the at least one arm-strapping yoke is forced into the structure thereby securing the mounting bracket to the structure.

The details of various embodiments of the claimed invention are set forth in the accompanying drawings and the description below. Other features and advantages will become apparent from the description, the drawings, and the claims.

### BRIEF DESCRIPTION OF THE DRAWINGS

The present invention can be more easily understood and further advantages and uses thereof more readily apparent, when considered in view of the detailed description and the following figures in which:

FIG. 1A is a side perspective view of a mounting system in accordance with one embodiment of the present invention;

FIG. 1B is a side perspective view of a mounting bracket and housing in accordance with one embodiment of the present invention;

FIG. 2 is a flow diagram of a method of mounting a housing to a structure in accordance with one embodiment of the present invention;

FIG. 3 is a side view of an arm in accordance with one embodiment of the present invention;

FIGS. 4A-4D are top views of different embodiments of strapping yokes of the present invention;

FIG. 5 is a side view of an outrigger in accordance with one embodiment of the present invention; and

FIG. 6 is a top view of a mounting system mounted to a pole in accordance with the present invention.

Like reference numbers and designations in the various drawings indicate like elements.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that mechanical changes may be made without departing from the spirit and scope of the present invention. The following detailed description is, therefore, not to be taken in a limiting sense, and the scope of the present invention is defined only by the claims and equivalents thereof.

For the reasons stated above and for other reasons stated below which will become apparent to those skilled in the art upon reading and understanding the present specification, there is a need in the art for a method and apparatus of mounting devices in a secure manner without having to use different models of mounting systems on different size poles. Embodiments of the present invention provide a mounting method and system for mounting a housing to a structure such as a pole, building or the like. Each of the embodiments of mounting systems described herein can be used on structures (such as poles) having a variety of shapes.

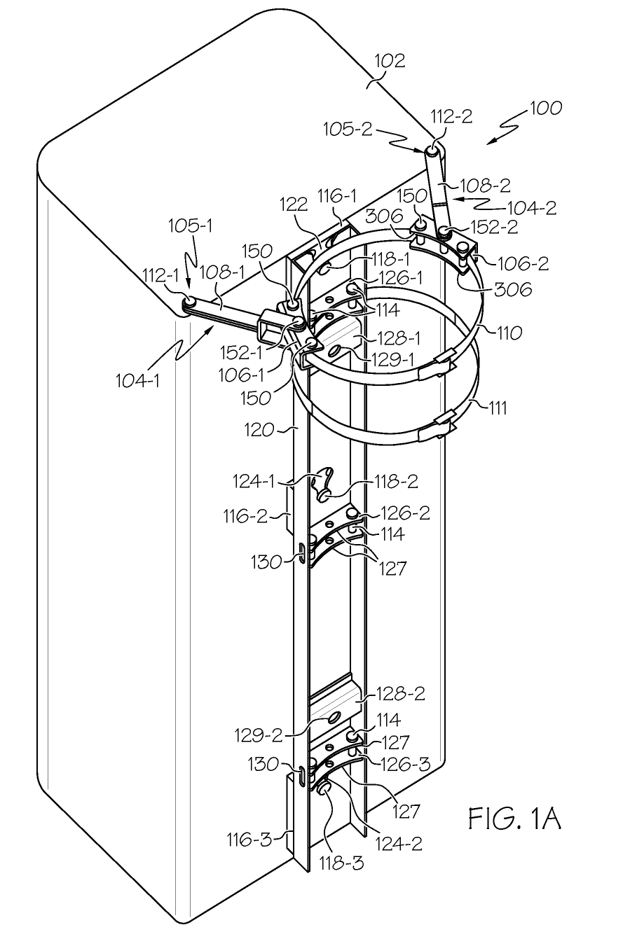

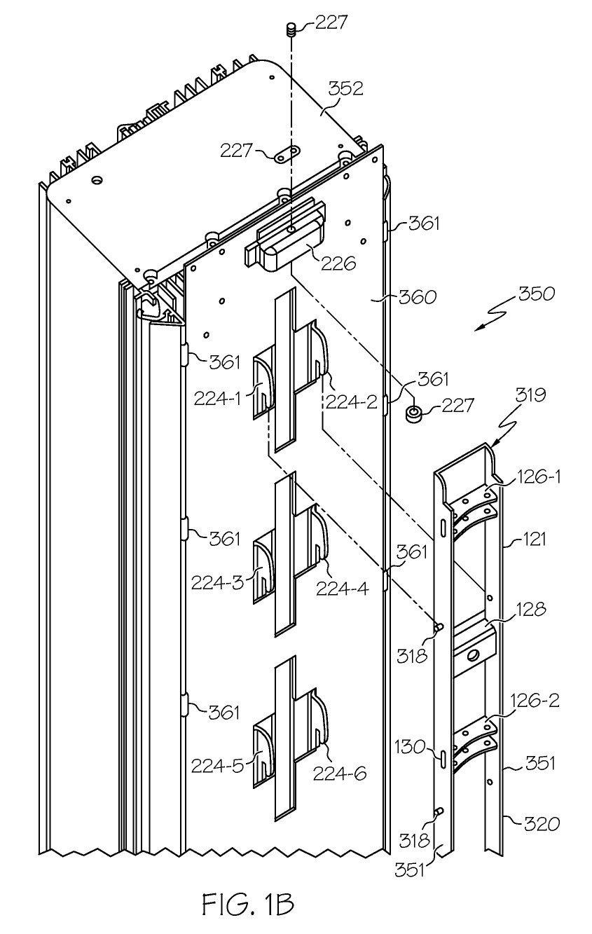

FIG. 1A is a side perspective view of a mounting system 100 in accordance with one embodiment of the present invention. FIG. 1B is a side perspective view of a mounting bracket 320 and a housing 352 in accordance with one embodiment of the present invention. As shown in FIG. 1A, the mounting system 100 is mounted to a housing 102. The mounting system 100 includes a mounting bracket 120, outriggers 104-1 and 104-2, and banding straps 110 and 111. The housing 102 (such as a cabinet for electronics) to be mounted on the structure (such as a pole) includes mating structures 118(1-3) on the housing 102. The mating structures 118(1-3) are configured to mate with the supporting structures 122 and 124(1-2) in the mounting bracket 120. In particular, mounting plates 116(1-3) include respective mating structures 118(1-3), also referred to herein as shoulder rivets 118(1-3). The shoulder rivets 118(1-3) are received in respective supporting structures 122, 124-1, and 124-2, also referred to herein as cutouts 122, 124-1, and 124-2, in the mounting bracket 120. The respective cutouts 122, 124-1, and 124-2 are shaped so that the housing 102 can be easily maneuvered to place the shoulder rivets 118(1-3) in the respect cutouts 122, 124-1, and 124-2 and lock the shoulder rivets 118(1-3) in place when the housing 102 is lowered into a respective narrow channel formed by each cutout 122, 124-1, and 124-2. Hence, the shoulder rivets 118(1-3) and the cutouts 122, 124-1, and 124-2 on the mounting bracket 120 enable a relatively easy mounting of the housing 102. This can be very beneficial feature when a heavy housing 102 is to be mounted to a structure.

Some embodiments of the mounting system include the mounting bracket 320 and a housing 352 as shown in FIG. 1B. In this case, the housing 352 to be mounted on the structure includes mating structures 224(1-6) on the back side of the housing 352. In one implementation of this embodiment, the mating structures 224(1-6) are integrated into the housing 352 via a plate 360 that is attached to the housing 352 by attachment features 361. In another implementation of this embodiment, the mating structures 224(1-6) extend from the back surface the housing 352. The mating structures 224(1-6) are configured to mate with the supporting structures 318 one the mounting bracket 320. The supporting structures 318 shown in FIG. 1B are pins 318 that extend from the sides 351 of the mounting bracket 350. Other forms of supporting structures are possible.

The pins 318 are received in respective mating structures 224(1-6), also referred to herein as flanges 224(1-6), in the mounting bracket 320. The respective flanges 224(1-6) are shaped so that the housing 352 can be easily maneuvered to place the pins 318 in the respect flanges 224(1-6) and secure the housing 102 to the mounting bracket 320. As shown in FIG. 1B, a secondary mating structure 226 is positioned at the top of the back of the housing 352. The secondary mating structure 226 is configured to hold the top end 319 of the mounting bracket 320 when the pins 318 are positioned in the respect flanges 224(1-6). In one implementation of this embodiment, securing attachments 227 are used to secure the top end 319 of the mounting bracket 320 within the secondary mating structure 226.

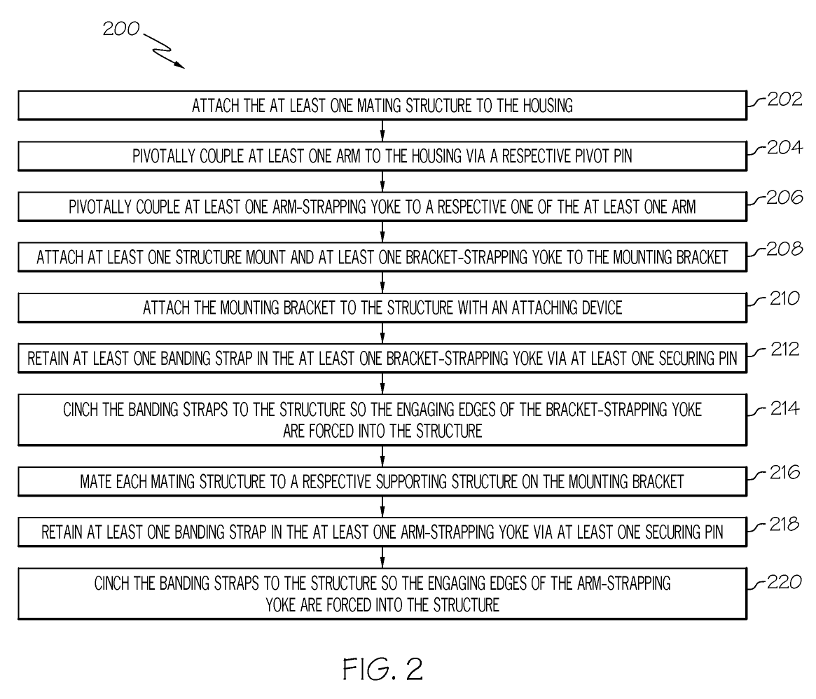

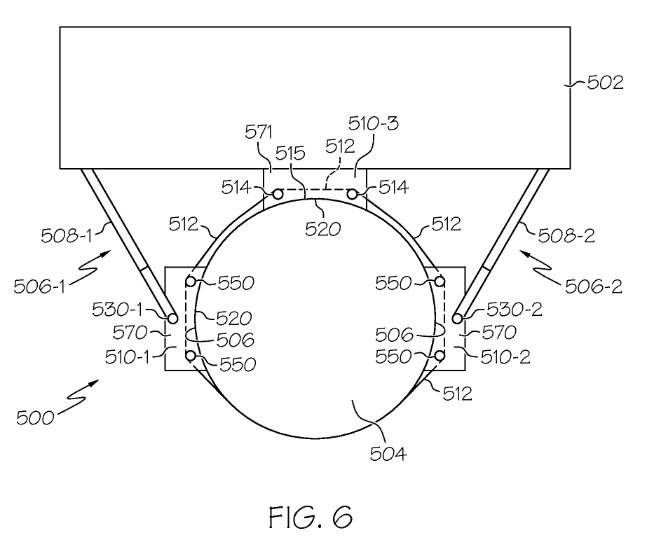

FIG. 2 is a flow diagram of a method 200 of mounting a housing to a structure in accordance with one embodiment of the present invention. The mounting system 100 can be used to mount the housing to structures having various shapes and sizes. For example, if the structure is a pole, the same the mounting system 100 is configurable to attach the housing 102 (or 352) to poles of various diameters. The method of mounting a housing to a structure is described with reference to the mounting systems 100 of FIG. 1A and the structure (pole 504) shown in FIG. 6. Method 200 can be implemented using the mounting bracket 320 and a housing 352 shown in FIG. 1B in a mounting system. It is to be understood that method 200 can be implemented using other embodiments of the mounting system as is understandable by one skilled in the art who reads and understands this document.

Referring now to FIG. 1A, the outriggers 104-1 and 104-2 each include an arm 108-1 and 108-2 and arm-strapping yokes 106-1 and 106-2, respectively. As defined herein an arm-strapping yoke is a yoke pivotally connected to an arm, such as, arm 108-1, in a configuration that permits the arm-strapping yoke to be strapped to a structure by a banding strap 110.

At least one mating structure is attached to the housing 102 (block 202). In one implementation of this embodiment, the mounting plates the mounting plates 116(1-2) including respective shoulder rivets 118(1-2) are attached to the housing 102 as shown in FIG. 1A. In another implementation of this embodiment, plate 361 having mating structures 224(1-6) is attached to the housing 352 as shown FIG. 1B.

At least one arm 104(1-2) is pivotally coupled to the housing 102 via a respective pivot pin 112(1-2) (block 204). The arms 108-1 and 108-2 of each respective outrigger 104-1 and 104-2 are pivotally coupled to the housing 102 via pivot pins 112-1 and 112-2 inserted through apertures in respective attaching ends 105-1 and 105-2. The arms 108-1 and 108-2 of each respective outrigger 104-1 and 104-2 are also pivotally coupled to the respective arm-strapping yoke 106-1 and 106-2 via coupling pins 152(1-2) (block 206).

Structure mounts 128-1 and 128-2 are solidly attached to the mounting bracket 120 (block 208). Also, bracket-strapping yokes 126-1, 126-2 and 126-3 are solidly attached to the mounting bracket 120 (block 208). As defined herein a bracket-strapping yoke is a yoke securely affixed in or on the mounting bracket 120 in a configuration that permits the bracket-strapping yoke to be strapped to a structure by a banding strap.

The structure mounts 128-1 and 128-2 are used to attach the mounting bracket 120 to a structure via respective apertures 129(1-2) with a bolt or similar attaching device (block 210). The mounting bracket 120 is mounted to a pole (also referred to herein as “structure”) by bolts or screws inserted through apertures 129(1-2) in the structure mounts 128-1 and 128-2 and screwed into the structure.

A banding strap 111 is retained in the bracket-strapping yoke 126-1 via securing pins 114 that are inserted in select apertures of the bracket-strapping yoke 126-1 (block 212). Likewise, the bracket-strapping yokes 126(2-3) are operable to retain similar banding straps. The mounting bracket 120 has apertures 130 that allow the banding straps 110 to be inserted in the respective bracket-strapping yokes 126. The banding straps 111 (only one of which is shown) are strapped and cinched (tightened) around the structure (such as, the pole 504 shown in FIG. 6) and around the securing pins 114 in respective bracket-strapping yokes 126-1, 126-2 and 126-3 to strengthen the attachment of mounting bracket 120 to the pole (block 214). The pressure asserted on the securing pins 114 of the bracket-strapping yokes 126-1, 126-2 and 126-3 force an engaging edge 127 of the bracket-strapping yokes 126-1, 126-2 and 126-3 into the pole thereby securing the mounting bracket 120 to the pole.

Each of the at least one mating structure is mated to a respective at least one supporting structure on the mounting bracket (block 216). In one implementation of this embodiment, the housing 102 is secured on the mounting bracket 120 via at least one mating structure 118(1-3) on the housing 102 mated to a respective supporting structure 122 and 124(1-2) on the mounting bracket 120. The mounting bracket 120 is secured to the housing 102 via the mounting plate 116, which was solidly secured to the housing 102 at block 202. In another implementation of this embodiment, the housing 352 is secured on the mounting bracket 320 via flanges 224(1-6) on the housing 352 mated to respective pins 318 on the mounting bracket 320.

The length of the arms 104(1-2) are adjusted to fit the diameter of the pole or structure which the banding strap 110 encircles. As illustrated in FIG. 1A, banding strap 110 is retained in the arm-strapping yokes 106-1 and 106-2 via securing pins 150 (block 218). The banding straps 110 and 111 are strapped around at least one securing pin 150 and a pole or similar structure (such as pole 504 illustrated in FIG. 6 and as described below with reference to FIG. 6). The banding strap 110 is cinched to the securing pins 150 and the structure so that the engaging edges 306 of the arm-strapping yokes 106(1-2) are forced into the structure thereby securing the mounting bracket to the structure (block 220). In this manner, the outriggers 104-1 and 104-2 provide a buttress, as well as an attachment, for the housing 102 to prevent the shifting of the housing 102 that may occur due to winds or other forces on the housing 102 (FIG. 1A).

Thus, according to the flow of method 200, the mounting system 100 is mounted after the housing 102 and the mounting bracket 120 are prepared. The housing 102 or 352 is then lifted up and attached to the supporting structures (e.g., 122 and 124(1-2) in the mounting bracket 120 or pins 318 on the mounting bracket 320). The banding strap 110 is strapped and tightened around the securing pins 150 (and in some cases, around the coupling pins 152) in both of the arm-strapping yokes 106-1 and 106-2 and around the structure. The pressure asserted on the securing pins 150 of the arm-strapping yokes 106-1 and 106-2 force the engaging edges 306 of the arm-strapping yokes 106-1 and 106-2 into the pole thereby securing the mounting system 100 to the pole. The sequence of steps in the flow of method 200 can vary as is understandable to one skilled in the art.

Although, FIG. 1A sets out a select number of bracket-strapping yokes 126, arm-strapping yokes 106, outriggers 104, structure mounts 128 and shoulder rivets 118, it is only an example of one embodiment. Likewise the number of pins 318 and flanges 224(1-6) shown in FIG. 1B can vary. Other embodiments use different numbers since every application will not be the same. Hence, the present invention is not limited to a select number of the elements as discussed above.

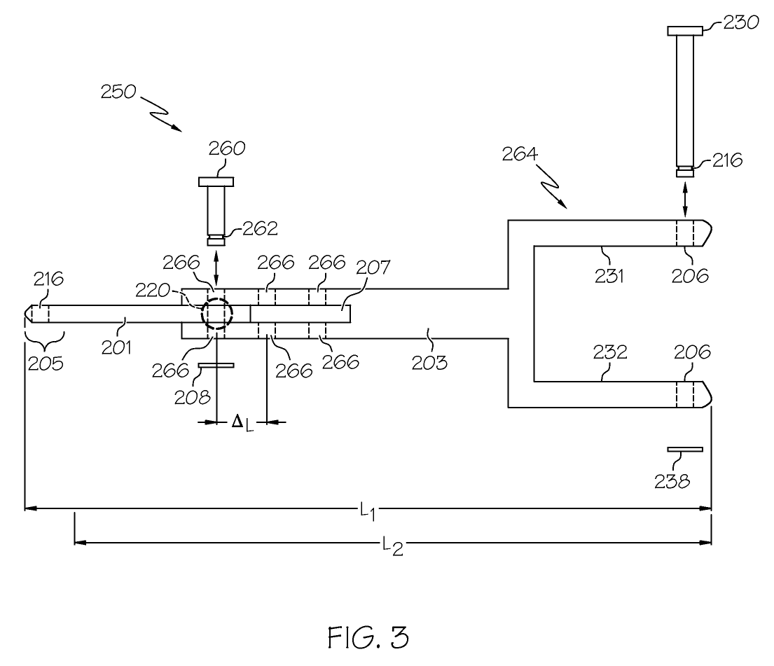

FIG. 3 is a side view of an arm 250 in accordance with one embodiment of the present invention. In this embodiment, the arm 250 can be adjusted in length. In particular, the arm 250 in this embodiment includes a first member 201 that slides into and out of a second member 203. The first member 201 has at least one first-member aperture represented generally at 220. The second member 203 has at least two second-member apertures 266 that extend through the cavity 207 into which the first member 201 slides. The center line of neighboring second-member apertures 266 are offset from each other by ΔL.

The length L of the arm 250 is selected by aligning one of the second-member apertures 266 in the second member 203 with a first-member aperture 220 in the first member 201 and sliding an adjustment pin 260 through both of the aligned second-member aperture 266 and the first-member aperture 220. Once inserted into the aligned second-member aperture 266 and the first-member aperture 220, the adjustment pin 260 is held in place by a fastener 238 (including, but not limited to, a C-clip, a snap ring, or a retaining ring) fitted in grove 262 of the adjustment pin 260. Thus, the arm 250 can have a plurality of lengths that differ by ΔL. As shown in FIG. 3, the length L₁ is ΔL greater than the length L₂ by ΔL. Other methods of length adjustment of the arm 250 are possible and the present invention is not limited to the example illustrated in FIG. 3. For example, the second member 203 may have a single second-member aperture 266 while the first member 201 has a plurality of first-member apertures 220.

The arm 250 also includes an attaching end 205 that includes aperture 216 to receive a pivot pin (such as, pivot pin 112-1 shown in FIG. 1A). The attaching end 205 is the end of the first member 201 that does not slide into the cavity 207 in the second member 203. The arm 250 also includes a receiving portion 264. The receiving portion 264 is at the end of the second member 203 that does not include the cavity 207.

The receiving portion 264 of the arm 250 includes a first plate 231 and a substantially parallel second plate 232 with the at least one coupling pin 230 coupled between. The first plate 231 and the parallel second plate 232 of the receiving portion 264 each include second-member apertures 266 through which coupling pin 230 is inserted. Coupling pin 230 stays in place via a fastener 238 (snap-ring) fitted in groove 216.

The coupling pin 230 is used to couple an arm-strapping yoke to the arm 250. The receiving portion 264 is shaped to accept an arm-strapping yoke (e.g., an arm-strapping yoke 106-1 shown in FIG. 1A) so that the coupled arm-strapping yoke pivots about the coupling pin 230. For example, as shown in FIG. 1A, the coupling pin 152-1 couples arm-strapping yoke 106-1 to the arm 104-1 so that the arm-strapping yoke 106-1 can pivot about the coupling pin 152-1. Other configurations of pins and fasteners can be used to hold an arm-strapping yoke in a receiving portion of an arm.

In one implementation of this embodiment, the first member 201 and the second member 203 are formed from metal, such as aluminum or steel. In another implementation of this embodiment, the arm is not adjustable in length. A fixed length arm adapts to various sized structures by a rotation of the arms 108-1 and 108-2 of each respective outrigger 104-1 and 104-2 that are pivotally coupled to the housing 102 via pivot pins 112-1 and 112-2. Since the banding is adjustable to various diameter poles or variously shaped structures, the fixed length outrigger is still able to secure the housing to the structure. A fixed length arm can be formed from a single piece of metal. In yet another implementation of this embodiment, the groove 212 and/or the groove 216 in the adjustment pin 260 and/or coupling pin 230 are replaced by an aperture that extends through an end of the adjustment pin 260 and/or coupling pin 230, respectively. In such embodiments, a securing wire or pin is inserted in the aperture to hold the pin in place.

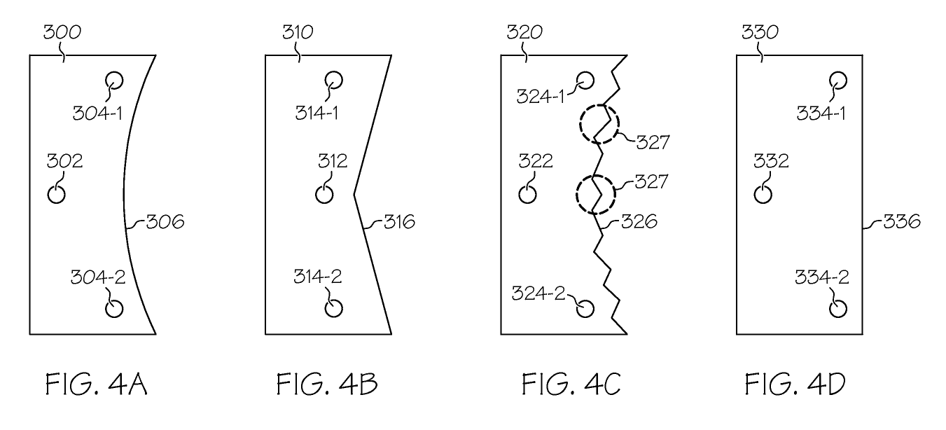

FIGS. 4A-4D are top views of different embodiments of arm-strapping yokes and bracket-strapping yokes of the present invention. The arm-strapping yokes and bracket-strapping yokes are also referred to herein as “strapping yokes.” FIGS. 4A-4D are top views of example embodiments of strapping yokes 300, 310, 320 and 330. Each of the strapping yokes 300, 310, 320 and 330 include an attachment aperture 302, 312, 322 and 332. The attachment apertures 302, 312, 322 and 332 are used to attach the strapping yokes 300, 310, 320 and 330, respectively, to an arm of a respective outrigger. Each of the strapping yokes 300, 310, 320 and 330 also include pairs of strap apertures 304-1/304-2, 314-1/314-2, 324-1/324-2, and 334-1/334-2. A respective pin (shown as securing pins 150 and 114 in FIG. 1A) is passed through the strap apertures 304-1/304-2, 314-1/314-2, 324-1/324-2, and 334-1/334-2. The pins retain the banding straps (shown as banding strap 110 in FIG. 1A) in the respective strapping yokes 300, 310, 320 and 330. In one embodiment illustrated in FIG. 4B the attachment aperture 312 and the strap apertures 314-1 and 314-2 are somewhat aligned so that the pin in the attachment aperture 312 can also be used to retain the banding strap.

Each of the strapping yokes 300, 310, 320 and 330 of FIGS. 4A-4D also illustrate an engaging edge 306, 316, 326, and 336, respectively. As illustrated, the engaging edges 306, 316, 326, and 336 have different shapes. The edges 306, 316, 326, and 336 illustrated are provided by way of examples not by way of limitation. Other shapes are contemplated depending on the shape of the structure the housing is to be mounted on. As illustrated, the example edges include a curve shaped edge 306 (FIG. 4A) that may be used for a pole structure. In one embodiment, the curvature of the edge 306 would match the curvature of the pole. The other examples include a V-shape edge 316 (FIG. 4B), an edge 326 with teeth represented generally at 327 (FIG. 4C), and a straight edge 336 (FIG. 4D). As discussed above, when the banding strap is tightened, the engaging edges 306, 316, 326, and 336 of the respective strapping yokes 300, 310, 320, and 330 are forced to abut a structure thereby securing the mounting system to the structure.

In one implementation of this embodiment, the edge 326 with teeth 327 includes more than one tooth shape, so that the shapes of the teeth are most likely to grip (or dig into) the structure thereby securing the mounting system to the structure. Embodiments of strapping yokes include edges that have portions with a smooth surface (of one or more radius of curvature) and portions with teeth-surfaces (the teeth being of one or more shapes). It is to be noted that the shape of the edges is determined by the position of the strapping yokes as used in the mounting system 100. For example, in an exemplary mounting system to mount a housing to a rectangular structure, the bracket-strapping yokes include straight edges 336 and the arm-strapping yokes include V-shape edges 316 designed to fit against a corner of the rectangular structure.

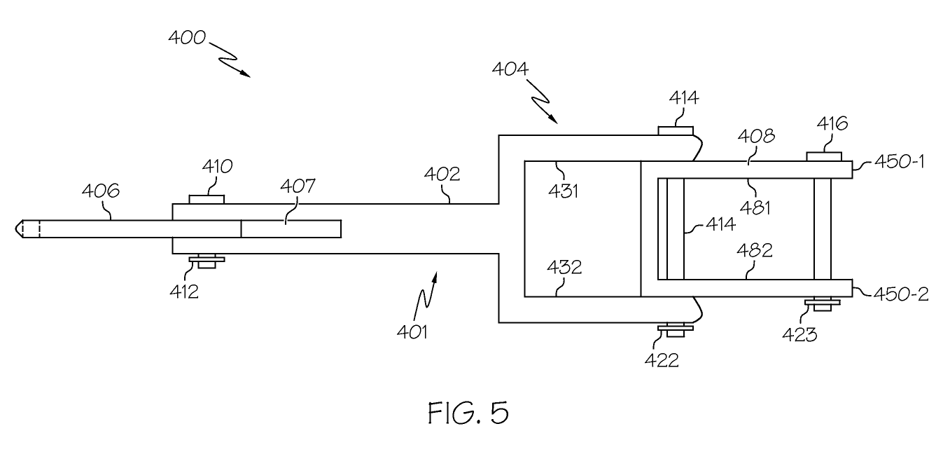

FIG. 5 is a side view of an outrigger 400 in accordance with one embodiment of the present invention. Referring to FIG. 5, a side view of the outrigger 400 of one embodiment is illustrated. As illustrated the outrigger 400 includes an arm 401 having a first member 406 that is slidably received in a cavity 407 in a second member 402 of the arm 401. The first member 406 of arm 401 is held in place within the second member 402 by pin 410 and a fastener 412 (e.g., snap ring). The outrigger 400 further includes a receiving portion 404. The receiving portion 404 of the arm 401 includes a first plate 431 and a parallel second plate 432 with the at least one coupling pin 414 coupled between. The strapping yoke 408 fits between the first plate 431 and the second plate 432 and is pivotally attached to the receiving portion 404 via coupling pin 414. The coupling pin 414 is held in place by fastener 422.

Also illustrated is securing pin 416, which is used to hold a banding strap between the first plates 481 and parallel plate 482 in the strapping yoke 408. The securing pin 416 is held in place by a fastener 423. The first engaging edge 450-1 of the first plate 481 and the second engaging edge 450-2 of the second plate 482 are configured to engage a surface of a structure to be mounted thereto.

FIG. 6 is a top view of a mounting system 500 mounted to a pole 504 in accordance with the present invention. The mounting system 500 includes a banding strap 512, outriggers 506-1 and 506-2, and a bracket-strapping yoke 510-3 attached to the housing 502. The bracket-strapping yoke 510-3 includes securing pins 514. The outrigger 506-1 includes an arm-strapping yoke 510-1 and arm 508-1. Coupling pin 530-1 pivotally connects the arm-strapping yoke 510-1 to the arm 508-1.

The outrigger 506-2 includes an arm-strapping yoke 510-2 and arm 508-2. Coupling pin 530-2 pivotally connects the arm-strapping yoke 510-2 to the arm 508-2. The arm-strapping yokes 510(1-2) includes securing pins 550.

The arm-strapping yokes 510(1-2) include a first plate 570 and a parallel second plate (not visible in FIG. 6) between which at least one pin 550 is received. Arm-strapping yokes 510-1 and 510-2 of outriggers 506-1 and 506-2 and bracket-strapping yoke 510-3 are used to retain the banding strap 512 that extends around the pole 504 and the securing pins 550 and 514. The banding strap 512 is received behind the securing pins 550 and between the first plate 570 and the second plate (shown as in FIG. 5) of the arm-strapping yokes 510-1 and 510-2, which are pivotally attached to the receiving portions (shown as 404 in FIG. 5). The banding strap 512 is also received behind the securing pins 514 and between the first plate 571 and the second plate (not shown as in FIG. 6) of the bracket-strapping yoke 510-3 that is attached to the housing 502.

To fix the mounting system 500 to the pole 504, the banding strap 512 is cinched tightly (tightened) around the pole 504 and the securing pins 514 and 550 so the engaging edges 506 of the bracket-strapping yoke 510-3 and of the arm-strapping yokes 510(1-2) engage the pole 504. Specifically, when the banding strap 512 is secured and cinched about the securing pins 514 and 550, the engaging edge 515 of the arm-strapping yoke 510-3 and the engaging edges 506 of the arm-strapping yokes 510(1-2) are forced into the surface 520 of the pole 504 (structure). Hence the versatility of the use of outriggers 506 in different configurations is illustrated.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. An outrigger comprising:
an arm including a receiving portion;
an arm-strapping yoke pivotally coupled to the receiving portion of the arm, the arm-strapping yoke having at least one engaging edge; and
at least one securing pin received in the arm-strapping yoke, the at least one securing pin configured to force the at least one engaging edge of the arm-strapping yoke into a surface of a structure when a banding strap received in the arm-strapping yoke is tightened around the structure and the at least one securing pin.

2. The outrigger of claim 1, wherein the receiving portion of the arm includes a first plate and a second plate, the second plate being substantially parallel to the first plate, and wherein the arm-strapping yoke is pivotally coupled via a coupling pin between the first plate and the second plate.

3. The outrigger of claim 1, wherein the arm-strapping yoke includes a first plate and a second plate, the second plate being substantially parallel to the first plate, and wherein at least one securing pin is received between the first plate and the second plate.

4. The outrigger of claim 1, the arm further having an attaching end configured to be pivotally coupled to a housing that is to be mounted on the structure.

5. The outrigger of claim 1, wherein the arm is adjustable in length.

6. The outrigger of claim 5, wherein the arm includes:
a first member having at least one first-member aperture;
a second member having at least two second-member apertures, wherein the first member slides into and out of the second member; and
an adjustment pin configured to slide through aligned apertures in the first member and the second member, wherein the arm is fixed at one of a plurality of lengths.

7. The outrigger of claim 1, wherein the at least one engaging edge is shaped to conform to a shape of the structure.

8. The outrigger of claim 1, wherein the at least one engaging edge includes teeth configured to engage the structure.

9. The outrigger of claim 1, wherein the shape of the at least one engaging edge is one of a curve, a V-shape, and a straight edge.

10. A mounting system, the system comprising:
at least one banding strap configured to pass around a structure;
at least one outrigger, each outrigger including:
an arm including a receiving portion;
an arm-strapping yoke pivotally coupled to the receiving portion of the arm, the arm-strapping yoke having at least one engaging edge; and
at least one securing pin received in the arm-strapping yoke, the at least one securing pin configured to force the at least one engaging edge of the arm-strapping yoke into a surface of the structure when a banding strap received in the arm-strapping yoke is tightened around the structure and the at least one securing pin.

11. The mounting system of claim 10, further comprising:
a mounting bracket having at least one supporting structure; and
at least one mating structure on a housing to be mounted on the structure, wherein the mating structure is configured to mate with the supporting structure, wherein the housing is coupled to the mounting bracket.

12. The mounting system of claim 11, wherein the supporting structure is a cutout in the mounting bracket and wherein the mating structure is at least one mounting plate coupled to a housing to be mounted on the structure, wherein each of the at least one mounting plates includes a shoulder rivet, wherein each shoulder rivet is configured to engage a respective one of the at least one cutout in the mounting bracket to mount the mounting plate on the mounting bracket.

13. The mounting system of claim 11, further comprising:
at least one bracket-strapping yoke having at least one engaging edge coupled to the mounting bracket, wherein the at least one engaging edge of the bracket-strapping yoke is shaped to conform to the shape of the structure, and wherein the at least one bracket-strapping yoke is configured to mount the mounting bracket to the structure with one of the at least one banding straps.

14. The mounting system of claim 10, further comprising:
at least one structure mount solidly attached to the mounting bracket, each structure mount configured to be attached to the structure.

15. The mounting system of claim 10, the arm of the outrigger further having an attaching end configured to be pivotally coupled to a housing that is to be mounted on the structure.

16. The mounting system of claim 10, wherein the arm of the outrigger is adjustable in length.

17. The mounting system of claim 10, wherein the at least one engaging edge of the arm-strapping yoke is shaped to conform to the shape of the structure.

18. The mounting system of claim 10, wherein the at least one engaging edge of the arm-strapping yoke includes teeth configured to engage the structure.

19. The mounting system of claim 10, wherein the shape of the at least one engaging edge of the arm-strapping yoke is one of a curve, a V-shape and a straight edge.

20. The mounting system of claim 10, wherein the receiving portion of the arm includes a first plate and a second plate, the second plate being substantially parallel to the first plate, and wherein the arm-strapping yoke is pivotally coupled via a coupling pin between the first plate and the second plate.

21. The mounting system of claim 10, wherein the arm-strapping yoke includes a first plate and a second plate, the second plate being substantially parallel to the first plate, and wherein at least one securing pin is received between the first plate and the second plate.

22. A method of mounting a housing to a structure, the method comprising:
pivotally coupling at least one arm to the housing via a respective at least one pivot pin;
pivotally coupling at least one arm-strapping yoke to a respective one of the at least one arm via a respective at least one coupling pin;
attaching at least one mating structure to the housing;
mating each at least one mating structure to a respective at least one supporting structure on the mounting bracket;
retaining at least one banding strap in the at least one arm-strapping yoke via at least one securing pin; and
cinching the at least one banding strap to the structure, wherein at least one engaging edge of the at least one arm-strapping yoke is forced into the structure thereby securing the mounting bracket to the structure.

23. The method of claim 22, wherein mating each at least one mating structure to a respective at least one supporting structure on the mounting bracket comprises:
attaching the at least one mounting plate to the housing, each of the at least one mounting plate including a respective shoulder rivet; and
placing the at least one shoulder rivet into a respective at least one cutout in the mounting bracket.

24. The method of claim 22, further comprising attaching at least one bracket-strapping yoke to the mounting bracket.

25. The method of claim 24, further comprising retaining at least one banding strap in the at least one bracket-strapping yoke via at least one securing pin, wherein cinching the banding straps to the structure further comprises forcing an engaging edge of the at least one bracket-strapping yoke into the structure.

26. The method of claim 22, further comprising
attaching at least one structure mount to the mounting bracket, wherein attaching a mounting bracket to the structure comprises attaching the structure mount to the structure with an attaching device.

27. The method of claim 22, further comprising adjusting a length of the at least one arm.
